(19) United States
(12) Patent Application Publication
(10) Pub. No.: US 2008/0301288 A1
(43) Pub. Date: Dec. 4, 2008

(54) METHOD AND DEVICE FOR MONITORING A TRANSACTION

(75) Inventors: Eyal Bychkov, Hod Hasharon (IL); Kaluski-Kimchi Sharon, Shaked (IL)

Correspondence Address: MARK M. FRIEDMAN, C/O DISCOVEY DISPATCH , 9003 FLIRIN WAY, UPPER MARLBORO, MD, 20772, US

(73) Assignee: SANDISK IL LTD., Kfar Saba (IL)

(21) Appl. No.: 11/964,755

(22) Filed: Dec. 27, 2007

Related U.S. Application Data
(60) Provisional application No. 60/940,417, filed on May 28, 2007.

(51) Int. Cl. G06F 15/173

(52) U.S. Cl. 709/224

(57) ABSTRACT

A device for detecting a timeout event during a transaction between a user and a host includes a memory storing a set of predetermined threshold values in association with corresponding operations. A timing control unit that is operative to provide timing information. A controller is operative to detect a timeout event based on the timing information provided thereto and on the predetermined threshold vale of a corresponding operation. Activation of the device is conditional upon a signal received from a host. In another example embodiment, a device for detecting a timeout event during a transaction between a user and a host based on timing information and the predetermined threshold values includes means to access external power from the host.

### CROSS-REFERENCE TO EARLIER-FILED APPLICATIONS

This patent application claims priority under 35 U.S.C. §119(e) to U.S. Provisional Patent Application No. 60/940,417, filed May 28, 2007, which is hereby incorporated by reference in its entirety.

### FIELD OF THE INVENTION

This invention relates generally to the field of monitoring a transaction between a user and a host by detecting timeout events.

### BACKGROUND OF THE INVENTION

In information security, a smartcard is a well known device for authenticating a user, e.g., to a host system, which provides a security-related or other service to the user. In systems using smartcard authentication, the authenticating means may be deemed to include both the physical smartcard itself and secret information (such as a password, PIN code, or the like), both of which are presumed to be in the sole possession of the user.

In these systems, when the user is authenticated, the host system typically “opens a session.” However, in many cases, the system does not require the authenticating means (either the smartcard itself or the secret information) to be present throughout the entire session. For example, many systems require the secret information (password, PIN code, fingerprint, etc.) to be entered only once, upon starting the session, and many systems return the smartcard to the user shortly after receiving the smartcard from the user, well before termination of the session. This situation, in which the session remains open in the absence of the authenticating means, presents a window of opportunity for malicious persons and malicious programs to use the open communication link between the smartcard and the host. This risk is typically reduced by use of a “timeout” feature that terminates the session automatically when the prolonged absence of a user is detected.

Prior art systems exist in which a timeout mechanism resides within the host or a remote server operated by the host and the timeout mechanism is implemented using open program code. However, in view of these aspects of the prior art systems, they are vulnerable to malicious programs (e.g., Trojan Horses).

### SUMMARY OF THE INVENTION

In view of the prior art and the present needs, it would be desirable to have a more robust device for detecting a timeout event during a transaction between a user and a host. Such a device may be configured to detect a timeout event based on timing information provided thereto and on predetermined threshold values of a corresponding one or more operations.

The operations may be any operation performed either by a user, by a host, or by the device during a transaction between the device and the host. Non-limiting examples for such operations may be powering up of the device, login of a user, internal processes performed by the host during the transaction, internal processes performed by the device during the transaction, etc. Note that an operation does not necessarily occur at a fixed point in time, and may vary in time depending on the type of transaction, configuration of the device and/or host being used, etc.

The device of the example embodiments may be provided to detect a timeout event in one or more operations as following: a single timeout event may be detected in one operation based on a single threshold value, or a single timeout event may be detected in one operation based on multiple threshold values, or a single timeout event may be detected in multiple operations based on one or more threshold values, or multiple timeout events may be detected in one or more operations based on a single threshold value, or multiple timeout events may be detected in one or more operations based on multiple threshold values. A predetermined threshold value may indicate a maximum-permitted point in time at which a transaction is occurring, a maximum-permitted duration of time of an operation of a transaction (for example, a duration of time of the host's processing a request from the user, or of an operation performed as part of such processing), a maximum-permitted duration of time between successive operations of a transaction (for example, a user's response time), etc.

A predetermined threshold value may depend on a single parameter (e.g. user profile) or on multiple parameters (e.g. user profile and communication link). Non-limiting examples for parameters may include the type of transaction performed between the device and a host (e.g. is it a secured transaction/a non-secured transaction), the communication channel between the device and the host (e.g. is communication via an ADSL line/via a dial-up line), user profile (e.g. is the user a disabled user/a standard user), and time of day (e.g. is a request for transaction performed during normal business hours/during the small hours of the night), to name a few.

The device may be, e.g., a memory card, such as a smart card configured to comply with a host, such as a telephone or an ATM machine. In contrast to the prior art discussed above, where a timeout event is detected by a program running on a host or a remote server, the example embodiments described herein include a device, other than a host or a remote server, that is configured to detect a timeout event. Such a device may prevent undesired programs and persons from accessing the device and communicating with the host, or reduce the risk of the same.

The device discussed herein may be compatible with any memory card format may, such as a secured digital (SD) memory card format used for storing digital media such as audio, video, or picture files. The device may also be compatible with a multi media card (MMC) memory card format, a compact flash (CF) memory card format, a flash PC (e.g., ATA Flash) memory card format, a smart-media memory card format, or with any other industry standard specifications. One supplier of these memory cards is SanDisk Corporation, assignee of this application.

The nonvolatile memory may retain its memory or stored state even when power is removed. The device may also apply to other erasable programmable memory technologies, including but not-limited to electrically-erasable and programmable read-only memories (EEPROMs), EPROM, MRAM, FRAM ferroelectric, and magnetic memories. Note that the device configuration does not depend on the type of removable memory, and may be implemented with any type of memory, whether it being a flash memory or another type of memory. The device may also be implemented with a one-time programmable (OTP) memory chip and/or with a 3 dimensional memory chip technology.

Host systems with which such memory cards are used include cellular telephones, personal computers, notebook computers, hand held computing devices, cameras, audio reproducing devices, and other electronic devices requiring removable data storage. Flash EEPROM systems are also utilized as bulk mass storage embedded in host systems.

In one example embodiment of the foregoing approach, a device for monitoring a transaction between a user and a host may include a memory, a timing control unit and a controller. The memory is provided to store a set of predetermined threshold values in association with corresponding operations. The timing control unit is operative to provide timing information (either real time or relative time) and may include a clock or a timer. The controller may be operative to detect a timeout event based on the timing information provided thereto and on the predetermined threshold value of a corresponding operation. Activation of the device is conditional upon a signal that is received from a host.

The controller may be operative to control a user's access to the memory upon the detection of a timeout event, to control a host's access to the memory upon the detection of a timeout event, and/or to control communication between the device and the host upon the detection of a timeout event. The controller may detect a timeout event based on the timing information provided thereto and on the predetermined threshold value of the corresponding operation. The detection may be performed in response to a request for a transaction with the host or in response to, but not necessarily any other operation or point in time. The controller may further transmit a signal to a remote server upon the detection of a timeout event. The timing control unit may also be embedded within the controller.

The controller may detect the timeout event based on transaction information being received from the host. The controller may also detect the timeout event when the timing information indicates that an elapsed time exceeds a threshold designated by the predetermined threshold value. The timeout event may be detected based for one or more operations; and the controller may detect the timeout event based on threshold values of multiple parameters. The device may be a smart card or a card reader. Accordingly, the controller may have a smartcard configuration or a card reader configuration.

In another example embodiment of the foregoing approach, a device for monitoring a transaction between a user and a host may include a memory, a timing control unit, a controller operative to detect a timeout event and means (such as an interface unit) to access external power from a host. The controller may be operative to detect a timeout event based on the timing information provided thereto and on the predetermined threshold value of a corresponding operation.

The controller may be operative to control a user's access to the memory upon the detection of a timeout event, to control a host's access to the memory upon the detection of a timeout event, and/or to control communication between the device and the host upon the detection of a timeout event. The controller may detect a timeout event based on the timing information provided thereto and on the predetermined threshold value of the corresponding operation. The detection may be performed in response to a request for a transaction with the host or in response to, but not necessarily any other operation or point in time. The controller may further transmit a signal to a remote server upon the detection of a timeout event. The timing control unit may also be embedded within the controller. The controller may detect the timeout event based on transaction information being received from the host. The controller may also detect the timeout event when the timing information indicates that an elapsed time exceeds a threshold designated by the predetermined threshold value. The timeout event may be detected based for one or more operations; and the controller may detect the timeout event based on threshold values of multiple parameters. The device may be a smart card or a card reader.

In another example embodiment of the foregoing approach, a method for monitoring a transaction between a device and a host may include providing a set of predetermined threshold values that are accessible by a device, the predetermined threshold values being in association with corresponding operations; providing timing information accessible by the device; and detecting, by the device, a timeout event based on the timing information and on a predetermined threshold value of a corresponding operation. Activation of the device may be conditional upon a signal received from a host; and/or the device may be operative to access external power from the host. The detecting may be performed by the device upon receiving a request for transaction with the host, or may be performed at any time and in response to any other operation.

The method may also include controlling a user's access to data stored on the device upon the detection of a timeout event, controlling a host's access to data stored on the device upon the detection of a timeout event, and/or controlling communication between the device and the host upon the detection of a timeout event, the controlling being performed by the device. The method may also include transmitting a signal to a remote server upon the detection of a timeout event. The detecting may be based on transaction information being received from the host and/or may be based on threshold values of multiple parameters. The detecting may be performed when the timing information indicates that an elapsed time exceeds a threshold designated by the predetermined threshold value, and the detecting may be performed for one or more operations.

Additional features and advantages of the example embodiments described will become apparent from the following drawings and description.

### BRIEF DESCRIPTION OF THE DRAWINGS

For a better understanding of the example embodiments, reference is made to the accompanying drawings, in which:

FIG. 1 is a block diagram of a device for detecting a timeout event, according to an example embodiment;

FIG. 2 is a block diagram of a device for detecting a timeout event, according to another example embodiment;

FIG. 3 is a block diagram of a device for detecting a timeout event, according to another example embodiment;

FIG. 4 is a block diagram of the device of FIG. 1 in communication with a host and a remote server; and

FIG. 5 is a flow chart of a method of detecting a timeout event during a transaction between a device and a host, according to an example embodiment.

### DETAILED DESCRIPTION OF PREFERRED EMBODIMENTS

The claims below will be better understood by referring to the present detailed description of exemplary and preferred embodiments. This description is not intended to limit the scope of the claims but instead to provide examples of such embodiments. The following discussion therefore presents exemplary embodiments of a method and a device for monitoring a transaction between a user and a host.

According to an example embodiment, a device is provided for monitoring a transaction with a host. As an example, the device may be one for use by a user to perform an action, receive a service, or the like, where the performance, receipt or the like requires the user to use the device to access or communicate with a host. As such, the device may be, e.g., a smartcard or a card reader.

A device for monitoring a transaction with a host may derive its power supply from a host (for example, a smartcard deriving its power from an ATM machine). In other words, the device need not employ any independent source of power, such as a battery, a charge pump, etc. According to one example embodiment, the device may be activated conditional on a signal, command or the like that is received from the host. (The terms “signal”, “command,” and like terms are to be understood in the broadest possible sense, consistent with the understanding of those of ordinary skill in the art. For the sake of convenience, they may be used interchangeably herein, and no such term is to be understood as dictating limitations on the physical substance thereof, the medium or mode of transmission thereof, etc.) The host may control the power that is provided to the device. Another example embodiment of the device may employ means (such as an interface unit having power lines) to access external power from the host. The device is configured to detect timeout events based on timing information and predetermined threshold values, both of which are provided or otherwise accessible thereto.

A predetermined threshold value may depend on a single parameter (e.g. user profile) or on multiple parameters (e.g. user profile and communication link). Non-limiting examples for parameters may include the type of transaction performed between the device and a host (e.g. is it a secured transaction/a non-secured transaction), the communication channel between the device and the host (e.g. is communication via an ADSL line/via a dial-up line), user profile (e.g. is the user a disabled user/a standard user), and time of day (e.g. is a request for transaction performed during normal business hours/during the small hours of the night), to name a few.

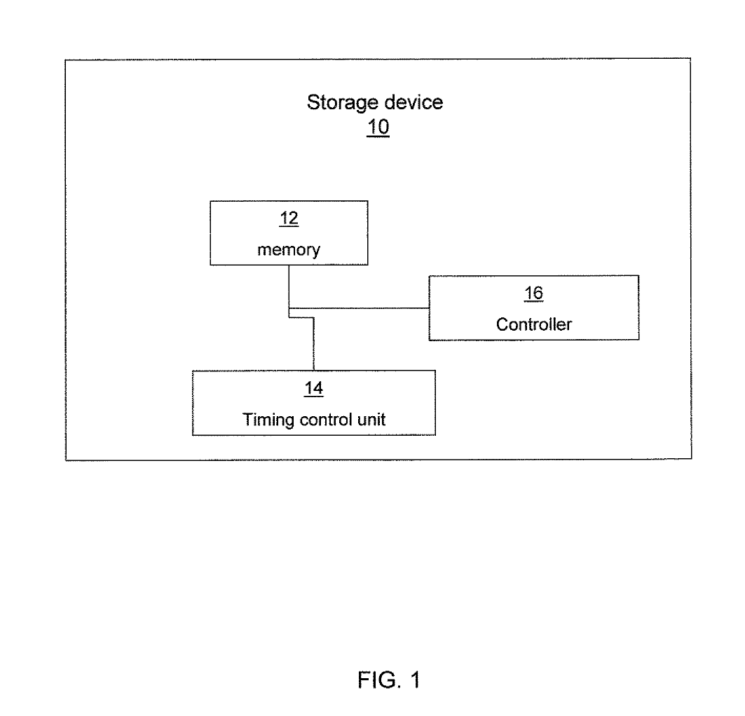

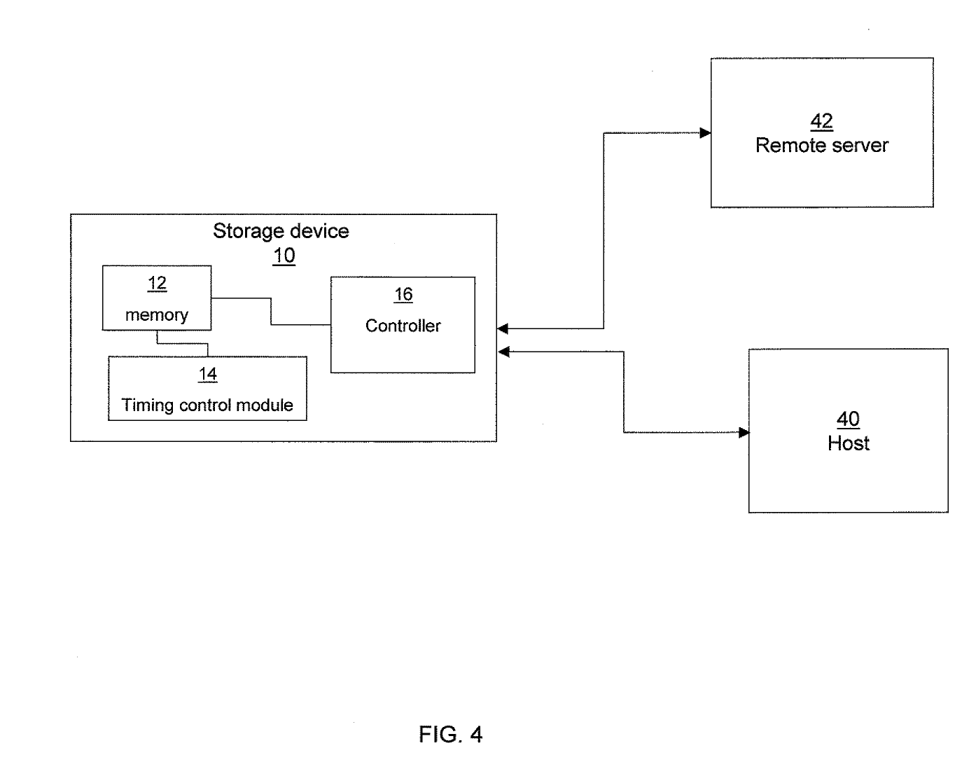

FIG. 1 is an exemplary block diagram of a device 10 for monitoring a transaction between a user and a host (see FIG. 4). Device 10 includes a memory 12, such as a non-volatile flash memory, storing one or more predetermined threshold values for different operations. Timing control unit 14 provides timing information to the device 10. Note that timing control unit 14 may include a clock providing real time information (such as the time and date) and/or a timer providing relative timing information (such as a duration of time between successive operations of a transaction), or the like. Activation of the device 10 may be initiated in response to a signal received from a host; or by means of an interface unit (see FIG. 4).

Device 10 further includes a controller 16 that is operative to detect a timeout event based on the timing information provided thereto and on the predetermined threshold values of a corresponding operation. The controller 16 may detect the timeout event when the timing information indicates that an elapsed time exceeds a threshold designated by the predetermined threshold value. The controller 16 may detect the timeout event for one or more operations and/or based on threshold values of multiple parameters.

The device 10 may be provided to detect a single timeout event may be detected in one operation based on a single threshold value, or a single timeout event may be detected in one operation based on multiple threshold values, or a single timeout event may be detected in multiple operations based on one or more threshold values, or multiple timeout events may be detected in one or more operations based on a single threshold value, or multiple timeout events may be detected in one or more operations based on multiple threshold values.

Controller 16 may be operative to control access to the memory 12 and/or to control communication between the device 10 and host 20 upon the detection of a timeout event. As examples of such control, controller 16 can be programmed to control a user's access to the memory 12 by, e.g., modifying the user's level of access to device 10 (i.e., modifying the extent of access to device 10 permitted to the user), or controller 16 can be programmed to control a host's access to the memory 12 by, e.g., terminating the transaction between the device and the host. As an additional example of such control, controller 16 can be programmed to switch between two different modes of operation (by, e.g. switching from read/write mode to read-only mode).

Instead of or in addition to any of the above types of control, controller 16 may be operative to transmit a signal to a remote server upon the detection of a timeout event. Controller 16 may also be arranged to perform other alternative or additional operations upon detection of a timeout event, suitable for the purposes discussed herein, such as would be known to those of ordinary skill in the art. The controller 16 may have a smartcard configuration, a card reader configuration, or other configuration suitable for the purposes discussed herein, such as would be known to those of ordinary skill in the art.

The predetermined threshold value may depend on a single parameter (e.g. user profile) or on multiple parameters (e.g. user profile and communication link). Non-limiting examples for parameters may include the type of transaction performed between the device and a host (e.g. is it a secured transaction/a non-secured transaction), the communication channel between the device and the host (e.g. is communication via an ADSL line/via a dial-up line), user profile (e.g. is the user a disabled user/a standard user), and time of day (e.g. is a request for transaction performed during normal business hours/during the small hours of the night), to name a few. The controller 16 may detect the timeout event based on transaction information being received from the host. “Transaction information” can be regarded as any information that is communicated to the device from the host to provide the device information about these parameters. The transaction information may be received via a signal that is transmitted from the host. The signal may be transmitted, but not necessarily, in response to a transaction request that is initiated by a user using the device. The transaction request may be also be initiated by the host or the like.

According to a first example, is provided a device that is operative to detect a timeout event at a single operation based on a threshold value of a single parameter. For the sake of this example, the operation may be selecting a service by a user after the user's login credentials are already provided to the device. The parameter may be the type of communication link between the device and a host. A first threshold value of 5 seconds is predetermined for this operation if the communication link between the device and host is an ADSL line; and a second threshold value of 30 seconds is predetermined if communication between device and host is a dial-up line. Hence, a timeout event may be detected, by the device, if a user does not select his/her requested service within 5 seconds in case of an ADSL line; or within 30 seconds in case of a dial-up line.

According to a second example, is provided a device that is operative to detect a timeout event at a single operation based on a threshold value of multiple parameters. In this example, the threshold values are based on a combination of two different parameters. For the sake of this example, the operation may be selecting a service by a user after the user's login credentials are already provided to the device. The first parameter may be the time of day, and the second parameter may be the user profile. A first threshold value of 5 seconds is predetermined for this operation if the current time of day is between 10 pm to 6 am and if the login credentials of the user indicate a standard user. A second threshold value of 10 seconds is predetermined for this operation if the current time of day is between 10 pm to 6 am and if the login credentials of the user indicate a disabled user. A third threshold value of 15 seconds is predetermined for this operation if the current time of day is between 6 am to 10 pm and if the login credentials of the user indicate a standard user. A fourth threshold value of 20 seconds is predetermined for this operation if the current time of day is between 6 am to 10 pm and if the login credentials of the user indicate a disabled user. Hence, a timeout event may be detected, by the device, if a standard user does not select his/her requested service within 5 seconds if the current time is between 10 pm to 6 am; or within 15 seconds if the current time is between 6 am to 10 pm. In case of a disabled user—a timeout event may be detected, by the device, if the disabled user does not select his/her requested service within 10 seconds between 10 pm to 6 am; or within 20 seconds between 6 am to 10 pm.

According to a third example, is provided a device that is operative to detect multiple timeout events at multiple operations based on a threshold value of one parameter. A first operation may be upon powering up of the device (when the user is being prompt to enter login information); and a second operation may be upon authentication of the user, by the device (when the user is prompt to select a service). The parameter may be the type of communication link between the device and a host. A first threshold value of 20 seconds is predetermined upon power up if the communication link between the device and host is an ADSL line; and a second threshold value of 30 seconds is predetermined upon power up if communication between device and host is a dial-up line. A third threshold value of 5 seconds is predetermined upon user authentication if the communication link between the device and host is an ADSL line; and a fourth threshold value of 10 seconds is predetermined upon user authentication if communication between device and host is a dial-up line.

According to a fourth examples is provided a device that is operative to detect multiple timeout events at multiple operations based on a threshold value of multiple parameters. A first operation may be upon powering up of the device (when the user is being prompt to enter login information); and a second operation may be upon authentication of the user, by the device (when the user is prompt to select a service). A parameter may be the type of communication link between the device and a host; and a second parameter may be user profile. A first threshold value of 10 seconds is predetermined upon power up if the communication link between the device and host is an ADSL line and the login information indicate a standard user; a second threshold value of 15 seconds is predetermined upon power up if communication between device and host is an ADSL line and the login information indicate a disabled user; a third threshold value of 20 seconds is predetermined upon power up if the communication link between the device and host is a dial-up line and the login information indicate a standard user; and a fourth threshold value of 25 seconds is predetermined upon power up if communication between device and host is a dial-up line and the login information indicate a disabled user. A fifth threshold value of 30 seconds is predetermined upon user authentication if the communication link between the device and host is an ADSL line and the login information indicate a standard user; a sixth threshold value of 35 seconds is predetermined upon user authentication if communication between device and host is an ADSL line and the login information indicate a disabled user; a seventh threshold value of 40 seconds is predetermined upon user authentication if the communication link between the device and host is a dial-up line and the login information indicate a standard user; and an eighth threshold value of 45 seconds is predetermined upon user authentication if communication between device and host is a dial-up line and the login information indicate a disabled user.

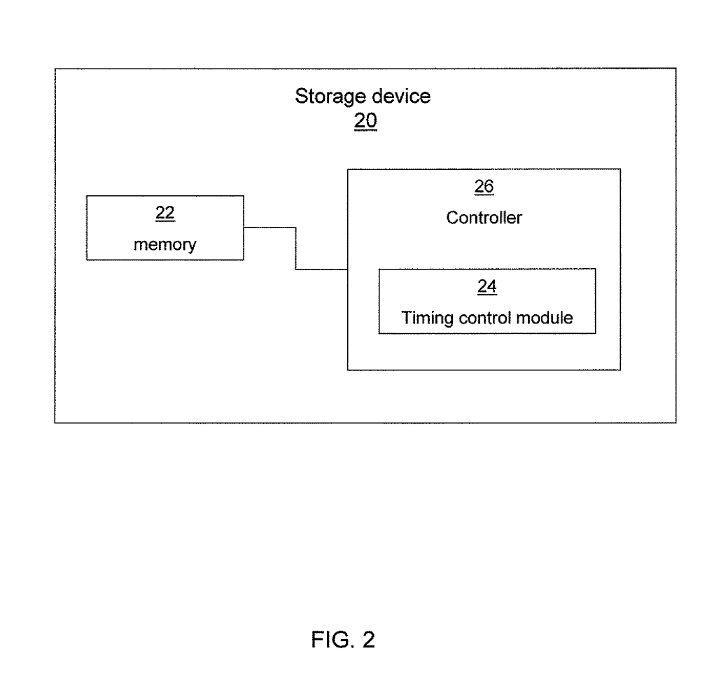

FIG. 2 is another example embodiment of a block diagram of a device 20 for monitoring a transaction between a user and a host. The device 20 includes a memory 22 and a timing control unit 24, in a similar manner to the corresponding components of the device of FIG. 1. In the example embodiment of FIG. 2, timing control unit 24 may be embedded within a controller 26.

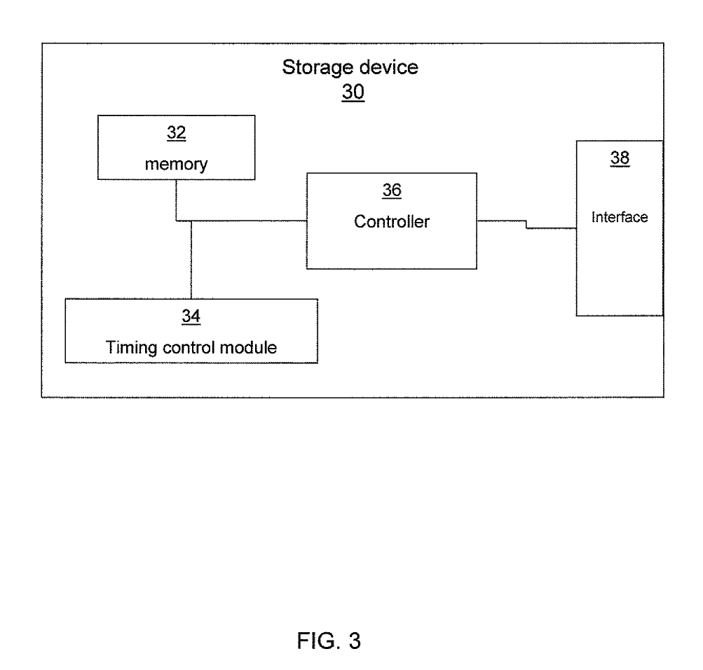

FIG. 3 is another example embodiment of a block diagram of a device 30 for monitoring a transaction between a user and a host. In the example embodiment of FIG. 3, an interface unit 38 is provided for accessing external power from a host. Device 30 also includes a memory 32, a timing control unit 34 and a controller 36, in a similar manner to the corresponding components of the device of FIG. 1. Interface unit 38 may access power from a host by means of power lines that are part of a set of input/output communication lines that are embedded within Interface unit 38. The set of input/output lines enable may also include address lines, data lines and any other means for enabling communication between the device 30 and the host. It is noted that it is also possible to embed timing control unit 34 in controller 36.

FIG. 4 is a block diagram of the device 10 of FIG. 1 in communication with a host 40 and a remote server 42. In an example embodiment, controller 16 may transmit a signal to the remote server 42 upon the detection of a timeout event. The signal may notify the remote server 42 that the user's response time exceeds a predetermined value, command or otherwise cause the remote server 42 to terminate the transaction between device 10 and host 40, limit or restrict communication between the user and device 10, and/or perform other desired operations.

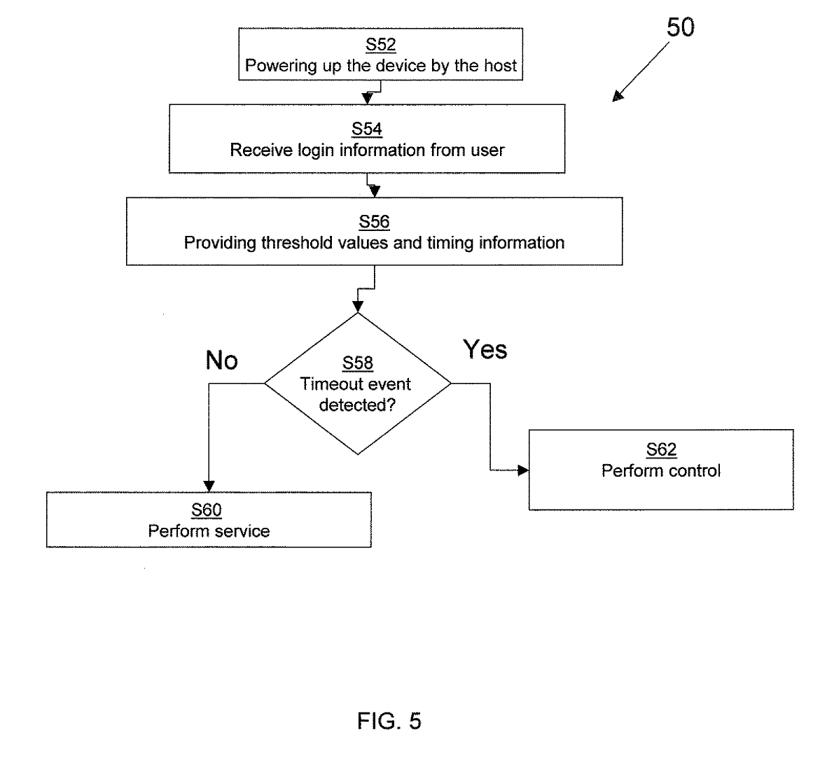

FIG. 5 is a flow chart of a method 50 for monitoring a transaction between a user and a host, according to an example embodiment. At the initial step S52 a device is powered up by the host. This step may be performed in response to a signal that is received from a host (for example, when inserting the device into a card reader or an ATM machine) or in any other way that enables the device to derive its power from the host.

At S54 log in information (e.g., user name and password) is received by the device from a user. The device may, but need not, be arranged to receive additional information, e.g., information pertinent to a transaction requested by the user, at S54.

Upon receipt of the login information (or of the login information and the additional information) at S54, timing information and a set of predetermined threshold values for corresponding operations are provided or made accessible to the device (S56). Timing information may be provided by the device starting an initial timer, or may be received by the device from an external unit. The predetermined threshold values may be provided for one or more operations and/or based on threshold values of multiple parameters. The predetermined threshold values may be real time information (such as the actual time and date) or may indicate relative timing (such as a duration of time between successive operations of a transaction). The predetermined threshold values may be provided by the device from transaction information received from the host. For example, a first threshold value may be set to one or more operations if the device detects that the communication link with the host is a dial-up link, and a second threshold value may be set if the device detects an ADSL link.

Next, at S58, the device detects a timeout event. The detection of the timeout event is performed based on the timing information and on the predetermined threshold value provided or made accessible to the device for the corresponding operation. A timeout event may be detected when the timing information indicates that an elapsed time exceeds a threshold designated by the predetermined threshold value. For example, if the user has not selected a service or his/her login credentials within a maximum-permitted predetermined threshold, has not provided login credentials on time, etc. A timeout event may be detected for one or more operations and/or based on threshold values of multiple parameters.

In the negative case (i.e. if a timeout event does not occur), then the service selected by the user is performed (S60).

In the affirmative case (S62), controlling is performed by the device. The device may be implemented to respond to the detection of a timeout event in different ways. For example, the device may be arranged to control access to the device's memory, and/or to control communication between device and a host upon detection of a timeout event. The controlling may be performed by the device based on the timing information and on the predetermined threshold value set for this operation. As an example, the detection of a timeout event, by the device, may limit or modify the user's level of access to the device. The controlling may be also performed by controlling the host's access to the device or controlling communication between the device and the host (for example, terminating the transaction between the device and the host). Alternatively or in addition, the device may be arranged to transmit a signal to a remote server upon detection of a timeout event. In this case, the remote server may be arranged to control access to the device's memory or to cause the device to control access to the memory.

It should be appreciated that the timeout events depicted herein should not be construed as limiting, as various implementations may set a wide range of predetermined thresholds for the detection of a plurality of timeout events during a transaction with a host. As mentioned above, a predetermined threshold may be determined for one or more operations depending on a single parameter (e.g. the communication link between the device and host), or depending on a combination of multiple parameters (e.g. the time of day, the user profile and type of transaction).

It should also be noted that the detection of a timeout event may not necessarily terminate the requested transaction or disable communication between the device and the host. As such, the detection of a timeout event may initiate any other action (e.g. transmit a warning signal only), or may not initiate any action at all.

Having described the various example embodiments of a system and method, it is to be understood that the description set forth herein is not meant as a limitation, as further modifications will suggest themselves to those skilled in the art, and it is intended to cover such modifications as fall within the scope of the appended claims.

1. A device for monitoring a transaction between a user and a host, the device comprising:
a memory operative to store a set of predetermined threshold values in association with corresponding operations;
a timing control unit operative to provide timing information; and
a controller operative to detect a timeout event based on the timing information provided thereto and on a predetermined threshold value of a corresponding operation, wherein activation of the device is conditional upon a signal received from a host.

2. The device of claim 1, wherein the timing control unit includes a clock and/or a timer.

3. The device of claim 1, wherein the controller is further operative to control a user's access to the memory upon the detection of a timeout event.

4. The device of claim 1, wherein the controller is further operative to control a host's access to the memory upon the detection of a timeout event and/or to control communication between the device and the host upon the detection of a timeout event.

5. The device of claim 1, wherein the controller is further operative to transmit a signal to a remote server upon the detection of a timeout event.

6. The device of claim 1, wherein the predetermined threshold value depends on at least one parameter of: a type of transaction between the device and the host, communication channel between the device and the host, or a user profile.

7. The device of claim 1, wherein the predetermined threshold value is time dependent, and wherein the predetermined threshold value indicates a point in time at which a transaction is occurring, a duration of time of an operation of a transaction, or a duration of time between successive operations of a transaction.

8. The device of claim 1, wherein the controller has a smartcard configuration or a card reader configuration.

9. The device of claim 1, wherein the controller detects a timeout event based on the timing information provided thereto and on the predetermined threshold value of the corresponding operation, in response to a request for a transaction with the host.

10. The device of claim 1, wherein the timing control unit is embedded within the controller.

11. The device of claim 1, wherein the controller detects the timeout event based on transaction information being received from the host.

12. The device of claim 1, wherein the controller detects the timeout event when the timing information indicates that an elapsed time exceeds a threshold designated by the predetermined threshold value.

13. The device of claim 1, wherein the controller detects the timeout event for one or more operations.

14. The device of claim 1, wherein the controller detects the timeout event based on threshold values of multiple parameters.

15. A device for monitoring a transaction between a user and a host, the device comprising:
a memory storing a set of predetermined threshold values in association with corresponding operations;
a timing control unit operative to provide timing information;
a controller operative to detect a timeout event based on the timing information provided thereto and on a predetermined threshold value of a corresponding operation; and
means to access external power from a host.

16. The device of claim 15, wherein the timing control unit includes a clock and/or a timer.

17. The device of claim 15, wherein the controller is further operative to control a user's access to the memory upon the detection of a timeout event.

18. The device of claim 15, wherein the controller is further operative to control a host's access to the memory upon the detection of a timeout event and/or to control communication between the device and the host upon the detection of a timeout event.

19. The device of claim 15, wherein the controller is further operative to transmit a signal to a remote server upon the detection of a timeout event.

20. The device of claim 15, wherein the predetermined threshold value depends on at least one parameter of: a type of transaction between the device and the host, communication channel between the device and the host, or a user profile.

21. The device of claim 15, wherein the predetermined threshold value is time dependent, and wherein the predetermined threshold value indicates a point in time at which a transaction is occurring, a duration of time of an operation of a transaction, or a duration of time between successive operations of a transaction.

22. The device of claim 15, wherein the controller has a smartcard configuration or a card reader configuration.

23. The device of claim 15, wherein the controller detects a timeout event based on the timing information provided thereto and on the predetermined threshold value of the corresponding operation, in response to a request for a transaction with the host.

24. The device of claim 15, wherein the timing control unit is embedded within the controller.

25. The device of claim 15, wherein the controller detects the timeout event based on transaction information being received from the host.

26. The device of claim 15, wherein the controller detects the timeout event when the timing information indicates that an elapsed time exceeds a threshold designated by the predetermined threshold value.

27. The device of claim 15, wherein the controller detects the timeout event for one or more operations.

28. The device of claim 15, wherein the controller detects the timeout event based on threshold values of multiple parameters.

29. A method for monitoring a transaction between a device and a host, the method comprising:
providing a set of predetermined threshold values accessible by a device, the predetermined threshold values being in association with corresponding operations;
providing timing information accessible by the device; and
detecting, by the device, a timeout event based on the timing information and on a predetermined threshold value of a corresponding operation,
wherein activation of the device is conditional upon a signal received from a host.

30. The method of claim 29, further comprising controlling a user's access to data stored on the device upon the detection of a timeout event, the controlling being performed by the device.

31. The method of claim 29, further comprising controlling a host's access to data stored on the device upon the detection of a timeout event and/or to controlling communication between the device and the host upon the detection of a timeout event, the controlling being performed by the device.

32. The method of claim 29 further comprising transmitting a signal to a remote server upon the detection of a timeout event.

33. The method of claim 29, wherein the predetermined threshold value depends on at least one parameter of: a type of transaction between the device and the host, a communication channel between the device and the host, or a user profile.

34. The method of claim 29, wherein the predetermined threshold value is time dependent, and wherein the predetermined threshold value indicates a point in time at which a transaction is occurring, a duration of time of an operation of a transaction, or a duration of time between successive operations of a transaction.

35. The method of claim 29, wherein the detecting is performed upon receiving a request for transaction with the host.

36. The method of claim 29, wherein the detecting is based on transaction information being received from the host.

37. The method of claim 29, wherein the detecting is performed when the timing information indicates that an elapsed time exceeds a threshold designated by the predetermined threshold value.

38. The method of claim 29, wherein the detecting is performed for one or more operations.

39. The method of claim 29, wherein the detecting is based on threshold values of multiple parameters.

40. The method of claim 29, wherein the device is operative to access external power from the host.
